(19) United States
(12) Patent Application Publication
(10) Pub. No.: US 2020/0134037 A1
(43) Pub. Date: Apr. 30, 2020

(54) NARRATION SYSTEM FOR INTERACTIVE DASHBOARDS

(71) Applicant: CA, Inc., Islandia, NY (US)

(72) Inventors: Serge Mankovskii, Islandia, NY (US); Maria Velez-Rojas, Islandia, NY (US); Steven Greenspan, Islandia, NY (US)

(21) Appl. No.: 16/171,778

(22) Filed: Oct. 26, 2018

(51) Int. Cl. G06F 17/30; G06F 17/28

(52) U.S. Cl. CPC G06F 17/3056; G06F 17/2881; G06F 17/30525; G06F 17/30572

(57) ABSTRACT

Provided is a process, including: receiving a command corresponding to user input to an interactive dashboard application from a user; producing in response to the command, instances of data visualizations depicting data to be visualized; generating, with a trained captioning model, one or more narrative captions determined to be descriptive of the produced instances of data visualizations, wherein the one or more narrative captions include a natural language description of a phenomenon exhibited, at least in part, by the data to be visualized and visually depicted in at least one of the produced instances of data visualizations; and causing the one or more narrative captions to be presented to the user.

### CROSS-REFERENCE TO RELATED APPLICATIONS

No cross-reference is presented at this time.

### BACKGROUND

### 1. Field

The present disclosure relates generally to data visualization and, more specifically, to a narration system for interactive dashboards.

### 2. Description of the Related Art

Industry is drowning in data. Whether in user's personal or professional life, computer users are presented with, an expected to extract insights from, ever increasing amounts of data. In many cases, the sources of this data is other computer systems and sensors of systems for which a given user is responsible or in which they have expressed an interest. In many cases, this data presents as a stream of data that unfolds over time, as a monitored system undergoes various changes. Often, users are expected to synthesize the data and detect and respond to such changes, but with the amount of data presented, in many cases, this can be exceedingly difficult.

To mitigate these challenges, various forms of computer-implemented data visualizations have been developed. In many cases, collections of such data visualizations are presented in dashboard applications, which in some cases depict a collection of data visualizations about a given system that are updated according to some schedule or responsive to certain events. Often the dashboard graphically summarizes a much larger corpus of data. But in many cases, even these approaches are failing to mitigate the above-described issues. Often, the amount of visual information in such dashboards is still more than a user can cognitively process, particularly when large volumes of information are depicted for fast-changing systems, and the user is responsible for several such systems.

### SUMMARY

The following is a non-exhaustive listing of some aspects of the present techniques. These and other aspects are described in the following disclosure.

Some aspects include a process, including: receiving, with one or more processors, a command corresponding to user input to an interactive dashboard application from a user, wherein: the interactive dashboard application is configured to present a plurality of instances of data visualizations in a dashboard user interface, the dashboard user interface comprises user-interface input elements, and the interactive dashboard application is configured to adjust, responsive to the input elements, which data visualizations are shown, attributes of the data visualizations, or which data is depicted in the interactive dashboard application; producing, with one or more processors, in response to the command, instances of data visualizations depicting data to be visualized; generating, with one or more processors, with a trained captioning model, one or more narrative captions determined to be descriptive of the produced instances of data visualizations, wherein the one or more narrative captions include a natural language description of a phenomenon exhibited, at least in part, by the data to be visualized and visually depicted in at least one of the produced instances of data visualizations; and causing, with one or more processors, the one or more narrative captions to be presented to the user.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a logical and physical architecture block diagram depicting an example of a computing environment in which natural language text summaries of data visualizations may be generated in accordance with some embodiments;

FIG. 2 is a flowchart depicting an example of a process by which natural language text summaries of data visualizations are generated in accordance with some embodiments;

FIG. 3 is a flowchart of an example of a process by which natural language text summaries are generated in the context of an interactive dashboard application in accordance with some embodiments;

FIG. 4 is a flowchart depicting an example of a process in which exposure to information in natural language text summaries of data visualizations is controlled in accordance with some embodiments;

FIG. 5 is a flowchart of an example of a process in which a data set is summarized by systematically varying data visualizations to a relatively large configuration space and generating natural language text descriptions thereof that are summarized with a text summarization model in accordance with some embodiments;

FIG. 6 is an example of an instance of a data visualization upon which some of the above-describe techniques may be applied; and

FIG. 7 is an example of a computing device by which the above-describe techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of machine learning and of human computer interaction. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Some embodiments mitigate some of the above-described issues and other issues by generating natural language text descriptions of phenomenon depicted in data visualizations. In many cases, in some embodiments, these natural language text descriptions are expected to more concisely inform a user of the significant phenomenon depicted in the data visualizations than the underlying data visualizations themselves. Indeed, in some cases, such natural language text descriptions may be provided to users without presenting the user the underlying data visualization, or the two collections of information may be presented in a staged user interface by which the user may navigate through to the underlying data visualization if the natural language text description of various phenomenon depicted therein is deemed by the user to warrant further investigation. Or in some cases, the natural language text descriptions may be presented concurrently alongside the data visualizations to provide context to a user and facilitate relatively fast interpretation by the user of the data visualizations.

In some embodiments, the natural language text description of phenomenon in data visualizations may be generated with a trained captioning model. Such models may be formed with a variety of techniques ranging from predefined candidate captions to sui generis natural-language text summaries generated based on computer-vision analysis of data visualization instances and trained natural-language text generation models in which a space of candidate captions is encoded by model parameters.

In some cases, during design of a data visualization, a data visualization designer may hand code various candidate natural language text descriptions or templates thereof and supply criteria indicating which states of the data visualization correspond to those descriptions. For example, a designer may associate a threshold on a bar chart corresponding to a company production goal with a natural language text description of “first-quarter production goal met.” Or in another example, a designer may associate a rule that matches to a threshold number of data points more than three standard deviations above a mean for a particular field of data over some trailing duration with a natural language text description of “outlier produced by production equipment unit XYZ.” In some cases, the natural language text descriptions are more concise that the described data visualization, e.g., consuming less data than one half, one tenth, or one hundredth of that which encodes the data visualization instance at issue. For instance, some natural language text descriptions are less than 1,000 words, less than 500 words, or less than 150 words.

Later, when a user that consumes the data visualizations requests a data visualization instance or is presented with an updated data visualization instance, the criteria supplied during the design phase may be compared to the current state of the data visualization instance and corresponding natural language text descriptions may be selected based on whether the criteria are satisfied. In some cases, natural language text descriptions having satisfied criteria may be presented to the user in such an event, or some embodiments may undergo further processing to summarize the descriptions or rank and filter the descriptions based on inferred relevance.

In some cases, the captioning model may be trained during the design phase or during use of data visualizations in production. In some embodiments, users may be afforded an interface by which feedback (e.g., in the form of structured data or unstructured data, like natural language text responses) may be entered indicating the relevance of the natural language text descriptions presented with data visualizations, and some embodiments may adjust the criteria based on such feedback. In some embodiments, during the design phase, fictional data, such as random data, simulated data, or sample historical data may be used to generate data visualizations that a user that are then used to generate natural language text descriptions presented to a user that provides feedback, thereby affording a source of feedback prior to release to production by which data visualization captions criteria may be adjusted.

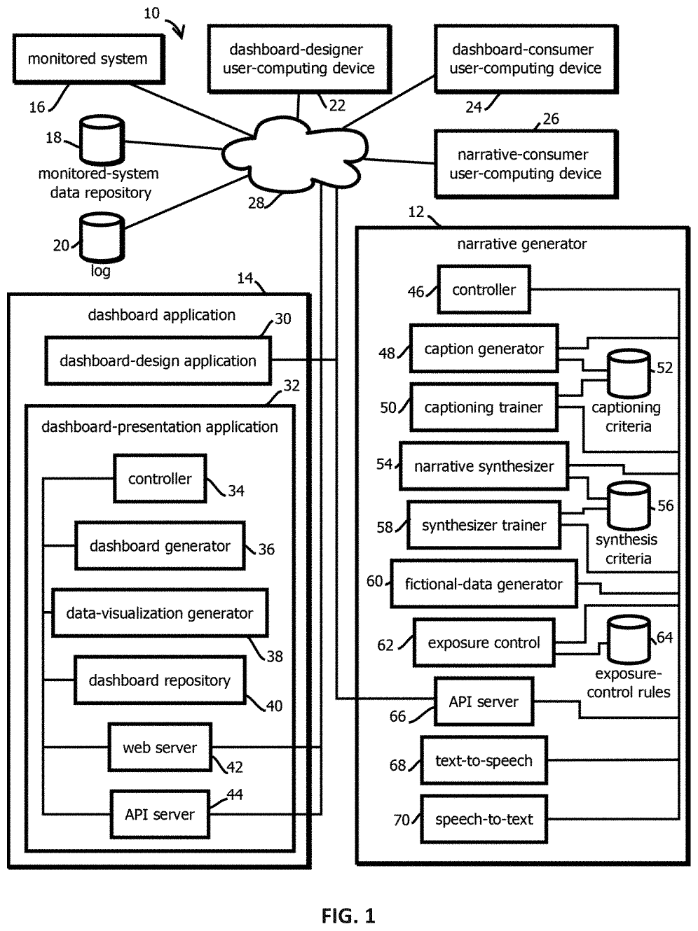

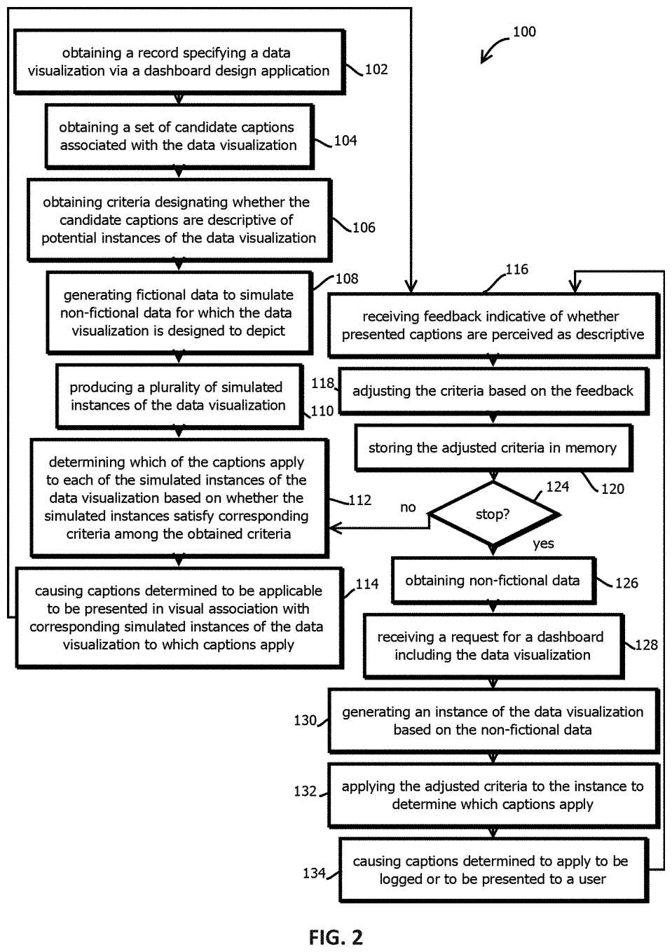

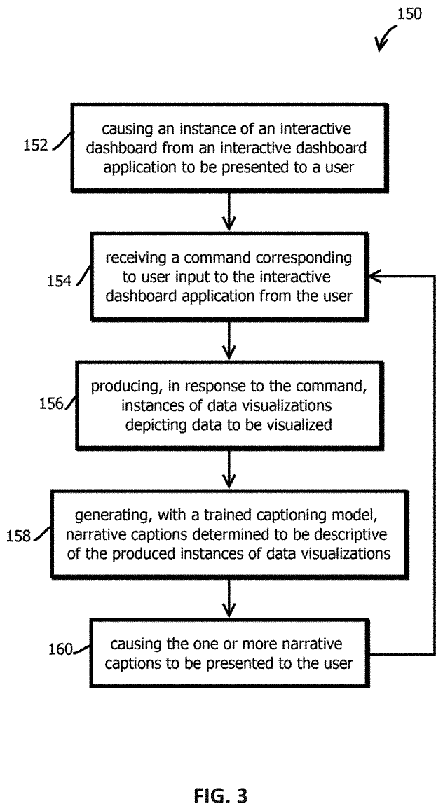

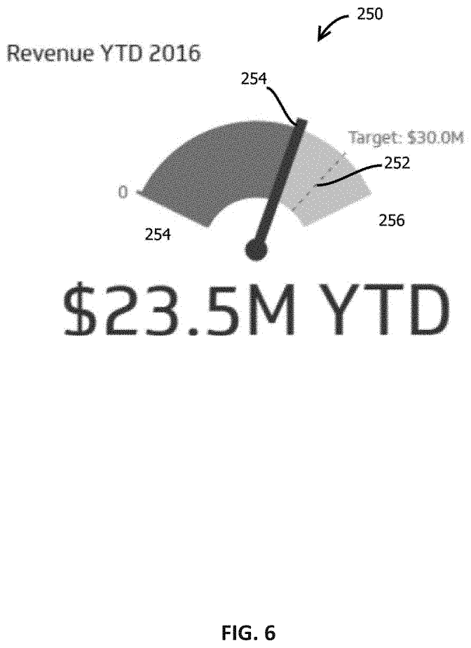

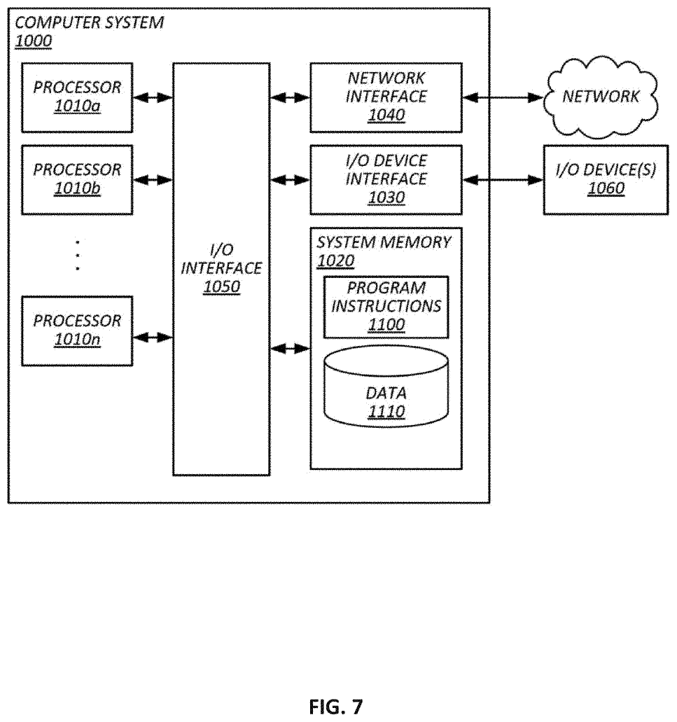

In some embodiments, these and other related techniques described below may be implemented in a computing environment 10 shown in FIG. 1. In some embodiments, the above techniques may be implemented with the process shown below in FIG. 2. Other techniques described below under other headings may be implemented with processes described below with reference to FIGS. 3-5, for example, by operating on data visualizations like that shown in FIG. 6, and in some cases within the computing environment 10 shown in FIG. 1. In some embodiments, these techniques may be used together synergistically, or in some cases they may be used independently, which is not to imply that other set of features are non-severable consistent with the present techniques. In some embodiments, these techniques may be implemented with a collection of computing devices like that described below with reference to FIG. 7, for instance, communicating via network, or as a monolithic application on a single computing device.

In some embodiments, the computing environment 10 includes a narrative generator 12 that generates the natural language text descriptions of instances of data visualizations and a dashboard application 14 that generates the data visualizations. In some embodiments, these data visualizations may depict data about a monitored system 16 stored in a monitored-system data repository 18, and the data visualization natural language text descriptions, in some cases, may be written to a log 20, such as an alarm log or event log, or (i.e., and/or) may be presented to a user via a dashboard-consumer user computing device 24. Various client devices may interact with the illustrated system. In some embodiments, the natural language text descriptions may be presented via a narrative-consumer user computing device 26 that is not used to view the underlying data visualizations or dashboards including those data visualizations. In some embodiments, dashboards or data visualizations therein, along with candidate natural language text descriptions and criteria for determining when those text descriptions applied to data visualizations may be supplied by a dashboard-designer user computing device 22, for instance, when a designer is designing data visualizations. In some embodiments, these components may communicate with one another via a network 28, such as the Internet or various local area networks.

The illustrated architecture is depicted as a distributed computing environment in which the various illustrated components may be geographically remote from one another and on different private subnetworks connected via the Internet, for instance, with the dashboard application 14 and the narrative generator 12 being remotely hosted and provided via a software as a service offering from a remote data center to a collection of tenants each having tenant accounts and each having different collections of instances of the computing devices and monitored system and related repositories, or in some cases, the narrative generator 12 and dashboard application 14 or one or both may be hosted on-premises, integrated with one another an any permutation as a single process or service on a host, or executed as a monolithic application on one of the illustrated computing devices, such as one in which the monitored system 16 runs.

In some embodiments, the monitored system 16 may be any of a variety of different types of systems that generate data one might want to visualize or have summarized in natural language text form. Examples include various stochastic systems having relatively high dimensional outputs, such as outputs including more than 10, more than 100, or more than 1000 different fields producing more than 10, more than 100, or more than 1000 different values in each of the fields per day. Examples include industrial production equipment, Internet-of-things appliances, automobiles, robotic systems, and computer systems. For example, the monitored system 16 may be an appropriately instrumented computing application or set of computing devices outputting streams of data indicating response times and errors of various subroutines or modules therein. Other examples include an issue tracker application outputting metrics indicative of response times for various reported bugs and bug report rates, or a source code repository indicating statistics on pull request and code commits. In some cases, output of the monitored system 16 may be fed to a monitored-system data repository 18, which in some cases, may be integrated therein or may be integrated with the other components 12 and 14.

In some cases, natural language text descriptions may be presented to users, or in some cases the natural language text descriptions may be written to a log of the system 16, such as log 20, without necessarily being presented to users, for instance, in an alarm log or other type of event log. In some embodiments, the monitored system 16 may include further logic that is responsive to various types of natural language text descriptions and takes action thereon within the context of the monitored system 16. In some embodiments, the output is to another machine learning model configured to match systems based on similarity of behavior, e.g., by matching text descriptions according to semantic similarity with, e.g., a bag-of-words model like Latent Semantic Analysis.

In some embodiments, the dashboard-designer user computing device 22 may be the same user computing device as devices 24 and 26 and in some cases the monitored system as well 16, or in some cases different devices may serve different roles and may be accessed by different users having different roles and permissions and related access credentials by which the users are selectively granted access to the monitored system 16, the dashboard application 14, or the narrative generator 12.

In some embodiments, a dashboard designer may access an account or other way of organizing program state in the dashboard application 14 to design (e.g., create or modify) dashboards or data visualizations therein and configure candidate natural language text descriptions and criteria thereof. In some embodiments, a user of the computing device 22 (or other population of users on other devices) may further receive simulated data visualization instances based on fictional data as described below, along with natural language text descriptions of phenomena appearing therein generated with a current set of criteria, and in some cases, that user may provide feedback via a user interface presented by the dashboard application 14 in a training mode. In some embodiments, the feedback may indicate whether natural language text descriptions correspond, in the user's view, to the depicted data visualization.

In some embodiments, natural language text descriptions may be customized based on the audience, e.g., according to personas or the below-described domains. In some cases, a feature that is an indicator of such an attribute may be input to the natural language text generation model and output may be determined based on such a feature. Similarly, in some cases, the feedback may be associated with a value for this feature to facilitate training that produces output suitable for different audiences.

Feedback may take a variety of different forms, including various forms of structured and unstructured data. In some embodiments, the feedback is a binary value indicating whether the text is relevant to the instance of the data visualization. In some embodiments, the feedback is a set of nominal values indicating various classifications, such as responsive, not responsive, relevant, not relevant, not interesting, interesting, and the like, e.g., in some embodiments, the feedback is vector with a score for each of these nominal classifications. In some embodiments, the feedback is an ordinal or cardinal value. In some cases, the feedback indicates a ranking associated with each of these different dimensions, such as a score from 0 to 5 of relevance, a score from 0 to 5 of whether the text is interesting in the user's view, and a score from 0 to 5 of whether the text is accurate. In some embodiments, each data visualization may have multiple natural language text descriptions associated with it, and in some cases the feedback may be a user-supplied ranking of the relevance of each of the natural language text descriptions presented or a ranking in any of the other listed dimensions. In some embodiments, any of the above-describe types of feedback may be applied to each of a set of natural language text descriptions presented in the feedback.

In some embodiments, feedback may also be received from users outside of this mode, for instance when the designed data visualization or text generated therefrom is released to production and used by consumers of data from the monitored system 16. In some embodiments, data visualizations may be presented on a dashboard-consumer user computing device 24, in some cases along with the generated natural language text descriptions generated for those instances of data visualizations by the narrative generator 12 as described below. In some embodiments, the text may be presented before the data visualization instances, and users may selectively click through to the data visualizations instances, for instance, by clicking on the text, or in some cases the narrative text description may be presented alongside the data visualization, either concurrently, or as an overlay, for instance, responsive to an event in which a user touches or hovers a pointer over the relevant portion of a data visualization in which the described phenomena is exhibited. Or as described below, the narrative description may be presented without showing the data visualization instance at all.

In some embodiments, narrative descriptions of phenomena and data visualizations may be presented to users on the narrative-consumer user computing device 26 without showing the data visualization. For example, some embodiments may present the narrative descriptions as a stream of text descriptions, like in a ticker-tape display, or some embodiments may present the text descriptions in emails, text messages, speech produced by a speech-to text engine, or the like. In some embodiments, both computing devices 24 and 26 are accessed by the same user, and the same user supplies the same access credentials, like a username and password to the dashboard application 14 or narrative generator 12 to receive dashboards, narrative text descriptions, or both. In some embodiments, the narrative-consumer user computing device 26 is a wearable computing device, like a head-mounted augmented reality display, a virtual reality headset, a smartwatch, an in-ear smart speaker, or the like. In some embodiments, the dashboard-consumer user computing device 24 is a smart phone, tablet, a wall-mounted display, an in-store kiosk, and in-dash automotive computer, a set-top box, a desktop computer, a laptop computer, a residential smart speaker display, or the like.

In some embodiments, dashboards and narrative texts may be presented through various client-side applications, including web browsers and native applications. In some embodiments, the narrative text descriptions of phenomena in data visualization instances may be pushed or pulled notifications sent to mobile computing devices. In some embodiments, narrative text descriptions of such phenomena may be presented as responses to user queries in any of the scenarios. In some cases, the presentation may be through various channels, like text messages, phone calls, emails, dashboard updates via an API, social media posts, webpage updates, and the like.

In some embodiments the narrative generator 12 is configured to generate natural language text descriptions of phenomenon depicted in data visualizations produced by the dashboard application 14. Terms like “generate” and “produce” or “form” are used interchangeably herein and should not be read to imply some distinct meaning in virtue of use of these different terms describing the creation of, or adjustment to, some data structure. A dashboard designer may implicitly or explicitly define an ontology of such phenomenon when designing natural language text descriptions, e.g., each description may describe a different phenomenon, or in some cases, the same phenomenon may be characterized multiple ways for different potential audiences.

In some embodiments, the dashboard application 14 includes a dashboard-design application 30 accessed by the dashboard-designer user computing device 22 to design a dashboard. In some embodiments, designing the dashboard may include designing data visualizations within the dashboard. In some embodiments, a given dashboard may include a plurality of different data visualizations, such as more than 3, more than 5, more than 10, or more than 50 concurrently displayed data visualizations. In some embodiments, designing may include adjusting an existing version of a dashboard design. In some embodiments, designing may produce a record that specifies (e.g., in part or in whole) the dashboard, for instance, indicating which data visualizations are included, the relative position of those data visualizations, and roles and permissions of users permitted to view the data visualization or narrative descriptions of phenomenon appearing therein, or subsets thereof.

In some embodiments, the dashboard design record may include a plurality of records corresponding to individual data visualizations that each specify how to construct instances of the individual data visualizations. In some embodiments, these data visualization records may indicate a title the data visualization, a type of the data visualization (e.g., a line chart, a bar chart, a pie graph, a force directed graph, Voroni diagram, a heat map, or the like), visual attributes of the data visualization (like colors, shadows, animated movements, fonts, dimensions of components in terms of display coordinates, and the like) and mapping of fields of monitored-system data to attributes of the data visualization, like to axes, bars, colors, and the like, along with scaling information for the mapping, like ranges to depict, units of quantization, log vs. linear scaling, and the like. In some embodiments, some data visualizations may include a single field, like in a line chart showing a trendline over time, or some embodiments may include multiple fields in multidimensional data visualizations, for instance, on X and Y axes or X, Y, and Z axes or with some dimensions mapped to colors or the like. In some embodiments, the record specifying the dashboard may reference the records specifying the data visualizations therein, and in some cases, these records may be consolidated into a single record, such as a records stored in a hierarchical data serialization format, like extensible markup language or JavaScript object notation.

In some embodiments, the dashboard-design application may cause a dashboard-designer user computing device to present a graphical user interface by which a designer may create this record specifying the dashboard. In some embodiments, that user interface may include inputs by which the designer at least partially specifies natural language text descriptions applicable to various states of the specified dashboard or data visualizations therein. Reference to a user interface should be read broadly to refer to both a collection of inputs and information presented that is displayed concurrently as well as the evolution of that arrangement over time, for instance as a user navigate through menus.

In some embodiments, the natural language text descriptions are fully constituted strings supplied by the designer, like a statement that “response times for database queries have exceeded the databases latency budget,” or “widget production for the quarter is more than three standard deviations above the mean.” Or “frequency of fluctuation in inventory changed from the previous month.”

In some embodiments, the natural language text descriptions supplied by the designer take arguments, for instance, with templates including a variable and instructions that specify how to assign a value to the variable. Examples including statements like “vibration amplitude on machine X correlates with setting Y” along with an instruction that maps the variable X to a foreign key in a table from which vibration amplitude is taken indicating an identifier of a piece of production equipment and along with an instruction maps the variable Y to another table indicating a state of settings of the machine corresponding to the value assigned X. In some embodiments, the variables may be mapped to statements in a query language, such as structured query language statements by which the variables are populate. Some embodiments dynamically form the natural language text description by replacing the variables with the values assigned to those variables. In some embodiments, the variables are mapped to functions that compute values for the variables based on the monitored-system data, for instance a variable mapped to a function that computes the largest value in a set of values, the smallest value in a set of values, the average value, or that selects value X if Y is true and value Z if Y is false. In some embodiments, designers may register functions called by a framework of the dashboard application for the variables to populate the variables.

In some embodiments, the designer may supply a relatively large number of such candidate natural language text descriptions (a phrase which is used broadly to refer both to a particular instance in which variables have been replaced with values and the template including the variables from which such an instance is formed). For example, a given data visualization may include more than 5, more than 50, or more than 500 candidate natural language text description supplied by the designer, depending upon the use case.

In some embodiments, each natural language text description may have associated therewith criteria indicating when the natural language text description applies to an instance of a data visualization. In some embodiments, the criteria may be criteria in rules, like a statement that if a value of some field exceeds a threshold, then the corresponding natural language text description is applicable to that instance of a data visualization. In some embodiments, each natural language text description may have associated therewith (e.g., in a one-to-one mapping, or in one-to-many mapping where criteria are expressed in a decision tree) criteria expressed in the form of a function that outputs a binary value indicative of whether the natural language text description applies, in some cases with nested if-then statements, loops, recursion, and the like. In some embodiments, the criteria may specify attributes of fields of the monitored system data, or in some cases, the criteria may specify visual attributes of an instance of a data visualization, like a criteria specifying that more than 20% of an area of a heat map must have the color red for the corresponding natural language text description to be determined to be applicable to an instance of that heat map.

In some embodiments, each natural language text description may further have associated therewith criteria indicating a relative relevance of the natural language text description to other natural language text descriptions that may potentially apply. In some embodiments, such criteria may take the form of a relevance score, which some embodiments may normalize with other relevance scores of other natural language text descriptions determined to be applicable, before ranking those applicable natural language text descriptions to select those natural language text descriptions having higher than a threshold rank for presentation. In some cases, relevance scores of functions by which the are calculated may be specified by the dashboard designer, or some embodiments may infer the scores based on user engagement with descriptions (e.g., based on click-through rates, dwell times after click through, gaze tracking, or the like). In some cases, the dashboard designer may supply these different types of criteria as part of the dashboard design process.

In some embodiments, the criteria may have various parameters that are adjusted in subsequent training operations. In some cases, those parameters include the text of the natural language text description itself, thresholds in the criteria, weights or other coefficients by which relevance scores are computed, functions by which values are mapped to variables, visual attributes of data visualization instances (including features of computer vision approaches) by which the natural lings text description is determined to be applicable or relevant, or ranges or thresholds of values of fields from the monitored-system data used to similar ends.

In some embodiments, the natural language text descriptions supplied by the designer are supplied by a trained natural language text generation model that can generate text even in the absence of hand coded text descriptions. For example, in some cases, the natural language text descriptions may be supplied by training such a model on a corpus of company reports in which images of data visualizations appear in association with natural language text discussing those data visualizations. Some embodiments may include a deep convolutional image detection neural network configured to detect various visual features in data visualizations and classify the data visualizations, for instance, in a pipeline in which features are detected, the data visualizations are classified by type based on the features, and then features are detected for the type in a pipeline.

In some embodiments the pipeline may further include a model configured to predict which text will appear given a type (and a dashboard identifier) and a set of such detected features in the corpus, examples including a recurrent neural network, a hidden Markov model, or various bag-of-word approaches in which relatively long n-grams suitable for use as descriptions are mapped, like a Latent Semantic Analysis model or a Latent Dirichlet Allocation model configured to associate in grams with topics having associated text content corresponding to the detected features. In some embodiments, once trained, the model may be configured to classify an image of a data visualization instance, detect features corresponding to that classification, and select n-grams or compose multi-token n-grams determined to be descriptive of the features. In some embodiments, the above-describe criteria may be implemented in the form of parameters of these machine learning models that are adjusted during training, for instance, in the form of weights or biases in neural networks, transition probabilities in hidden Markov models, and feature vectors in various bag-of-word models.

In some embodiments, the dashboard application includes a dashboard-presentation application 32. In some embodiments, the dashboard-presentation application 32 may be configured to receive a request for an instance of a dashboard, that request specifying a record like those described above that specify dashboards and identify either by reference, or by containing, records specifying data visualizations therein. In some embodiments, the dashboard-presentation application 32 may be configured to interpret the corresponding document, query the monitored-system data repository 18 for data within an extent of the data visualizations (for instance if the data visualization depicts values for a particular field over the previous six months, some embodiments may query the monitored-system data repository 18 for that field with the constraint of time specified), and produce the corresponding data visualization instances depicting the responsive data.

The term data visualization instance” is used herein to refer to the result of apply a data visualization to data depicted. For instance, a data visualization may specify a pie chart with a particular diameter, set of fields mapped to various colors, and text, without indicating the sizes of the different segments in the pie chart, while an instance of the data visualization may also include a specification of those different segment sizes based upon a depicted set of data responsive to a query to the monitored-system data repository 18. A data visualization instance need not be displayed on a display screen to be referred to as depicting data. A bitstream at rest on a hard drive encoding that data visualization instance can also constitute a data visualization instance, even if the bitstream is never used to render a graphical display. Data visualization instances may be encoded in a variety of different formats, including bitmaps, videos, vector graphics, and a collection of information from which such data formats may be formed (like the depicted data and the record specifying how to form a data visualization).

In some embodiments, to these ends and others, the dashboard-presentation application 32 may include a controller 34, a dashboard generator 36, a data-visualization generator 38, a dashboard repository 40, a web server 42, and an application program interface (API) server 44. In some embodiments, the controller 34 may coordinate the operation of these other components to effectuate the functionality described herein as attributed to the dashboard-presentation application 32. In some embodiments, the dashboard generator 36 is configured to construct dashboards from data visualizations generated by the data-visualization generator 38. These two components 36 and 38 may interpret the above-described records, which in some cases may be stored in a dashboard repository 40, query the monitored-system data repository 18 for the data to be depicted, and form the instances of data visualizations and arrange those instances in an instance of a dashboard.

In some embodiments these operations may be performed responsive to requests received via the web server 42 or the API server 44, which in some cases may be consolidated, which is not to suggest that any other described component may not also be consolidated with other components. In some embodiments, request for dashboards may be received from a browser via the web server 42 or from a native application or the narrative generator 12 or other computing devices via the API server 44, each of which in some cases may be a nonblocking server configured to pass requests to the controller 34 and advance responses back out through the network 28.

In some embodiments, the narrative generator 12 implements various portions or all of the processes described below with reference to FIGS. 2 through 5 to form narrative natural language text descriptions of phenomenon appearing in data visualizations, whether those data visualizations are presented to a user or not. In some embodiments, the narrative generator 12 may compare the criteria of the various candidate natural language text descriptions to an instance of a data visualization or dashboard to determine whether the criteria are satisfied and, and some cases, rank responsive natural language text descriptions based on relevance to produce a natural language text summary of an instance of a data visualization or dashboard with a plurality of data visualizations. Results may be output via any of the above-describe channels by which such information is presented to users or logged in log 20.

Again various use cases of the narrative generator 12 are described below with reference to different flowcharts, and it should be emphasized that these different use cases may be applied independently of one another, which is not to suggest that anything else described herein may not also be used independently of other described features. In some embodiments, the narrative generator 12 is integrated with the dashboard application or is a distinct application.

In some embodiments, the narrative generator 12 includes a controller 46, a caption generator 48, a captioning trainer 50, a captioning criteria repository 52, a narrative synthesizer 54, a synthesis criteria repository 56, a synthesis trainer 58, a fictional-data generator 60, an exposure-control module 62, an API server 66, and exposure-control rules repository 64, a text-to-speech module 68, and a speech-to-text module 70. In some embodiments, the controller 46 may coordinate operation of these various components to effectuate the functionality described herein.

In some embodiments, the caption generator 48 is operative to receive a data visualization instance and set of candidate natural language text descriptions and their associated criteria before determining which of the criteria are satisfied by the data visualization instance and, and some cases, determining relative relevance and filtering based on relative relevance those natural language text descriptions determined to have criteria that apply. In some cases, the natural language text may be expressed as a human readable sentence (with a subject and a predicate) or maybe a composition of a plurality of different natural language text descriptions determined to be applicable, such as a paragraph of such natural language text descriptions, in some cases preceded by or followed by a sentence that summarizes the natural language text descriptions that constitute a paragraph or other body of text, for instance, determined with the narrative synthesizer 54 described below.

In some embodiments, the caption criteria are stored in the captioning criteria repository 54, in some cases along with the associated natural language text descriptions, and some embodiments may adjust the captioning criteria with a captioning trainer 54. Some embodiments may adjust the criteria during the design phase, for instance, before releasing a dashboard to production, by generating a relatively large number of instances of data visualizations with fictional data, producing captions for those instances, and receiving feedback, for instance, from the designer or other trainer, and then adjusting the criteria responsive to the feedback.

Fictional data may take various forms, examples including random values for the fields of a data visualization, or a sampling of historical data for the fields for the data visualization. In some cases, historical data may not include values that produce phenomena for which natural language text descriptions are applicable or may not produce such natural language text descriptions with sufficient regularity to effectively train. Some embodiments may generate fictional data based on the criteria of the natural language text descriptions, for instance by training a generative machine learning model on the historical data of the monitored system and then adjusting or supplying inputs to the generative machine learning model that are configured to produce outputs for the fields that are realistic and also produce data visualization instances with phenomena corresponding to the criteria of the natural language text descriptions.

Or, in some cases feedback may be obtained after the dashboard is released to production, from users experiencing the output from non-fictional data. In some embodiments, a user interface in which dashboard data visualizations or narrative descriptions thereof are presented may include inputs by which a user may indicate whether the presented narrative description is relevant and responsive or descriptive of the current instance of a data visualization. Some embodiments may receive this feedback (or the other forms described above) and further adjust the captioning criteria or text descriptions.

Adjustments based on feedback may take a variety of forms. Some embodiments may incrementally adjust criteria responsive to a given instance of feedback, for instance, feedback indicating that a caption is not relevant or is not descriptive may cause criteria to be adjusted in a way that makes the criteria less likely to be satisfied, for instance raising a threshold or lowering threshold. In some embodiments, the criteria of narrative text descriptions that are not presented may be adjusted based on feedback, for instance those narrative text descriptions adjacent a threshold that were filtered out for relevance may be adjusted responsive to feedback indicating that those that were not filtered out were not relevant or descriptive. In some cases, such adjustments may in include making the criteria more permissive. In some cases, criteria may be disregarded during training to confirm that that the criteria is not causing a false negative result.

In some embodiments, the feedback may be collected into a training set, and the captioning criteria may be adjusted as a batch process based on the training set. For example, some embodiments may iteratively adjust the captioning criteria in a direction that tends to optimize an objective function, for instance, with a greedy or non-greedy optimization algorithm. Examples include optimization based on stochastic gradient descent, simulated annealing, genetic algorithms, evolutionary algorithms, and the like. For example, some embodiments may adjust weights and biases in one of the above-describe neural nets for generating natural language text descriptions in a direction that a respective partial derivative of the respective weights or biases with respect to the objective function indicates will optimize the objective function at least locally. Or some embodiments may adjust weights applied to various dimensions of feature vectors in bag-of-word models.

Some embodiments may include a narrative synthesizer 54 configured to receive multiple natural language text captions from the caption generator 48 and generate a body of natural language text that summarizes, or is composed of, the individual natural language text descriptions from the caption generator 48. The term caption and natural language text description are used interchangeably herein. In some embodiments, the narrative synthesizer 54 is configured to form a paragraph from a plurality of individual sentences each output by the caption generator 48, in some cases sequencing the sentences based on relevance, and in some cases composing a summary of the paragraph as a topic sentence, for instance, with an abstractive natural language text summarization model. In some embodiments, the narrative synthesizer 54 may be configured to execute an extractive natural language text summarization model to generate a summary of a plurality of natural language text descriptions for an instance of a dashboard. In some cases, the summary may be a summary of an individual data visualization instance, a phenomenon in a data visualization instance, or a phenomenon that spans multiple data visualizations in a dashboard instance, like a correlation.

In some embodiments, the narrative synthesis may be based on synthesis criteria stored in synthesis criteria repository 56. Such synthesis criteria may include stop words, term-frequency inverse document frequency scores, vectors in a word2vec model, a topic model based on topics in a corpus relevant to a monitored system's data visualizations, like the above-described set of historical human composed reports, or other bag of words approaches. Examples further include Latent Semantic Analysis, topic model, or word2vec models in which n-grams in generated captions may be clustered, and then an n-gram closest to a centroid of the cluster (e.g., as measured by cosine distance, Minkowski distance, or Euclidian distance) may be selected as a summary of the cluster by the synthesizer 54. In some embodiments, the synthesis criteria may be populated with the synthesizer trainer 58, for instance, by processing such a corpus.

Or in some cases, the narrative synthesizer 54 may execute a neural network configured to summarize text, for instance, with a sequence-to-sequence neural network model. Such models, in some cases, may include an encoder having a plurality of long short-term memory modules (e.g., in a recurrent neural network) coupled to a decoder similarly having a set of long short-term memory modules (e.g., in another recurrent neural network). The encoder may receive a sequence of n-grams in the larger body of text and output an intermediate-representation vector in a concept space, which may be received by the decoder. The decoder may convert that vector into a sequence of n-grams in a shorter body of natural language text the summarizes a longer sequence of tokens received as input to the encoder. In some embodiments, the synthesizer trainer 58 may be configured to adjust weights and biases in this sequence-to-sequence model based on feedback during training, based on feedback during use, or based on a corpus that pairs summaries with longer bodies of text, for instance, with the above-described optimization techniques, like with stochastic gradient descent.

Some embodiments may further include a fictional-data generator 60 that may execute the various techniques described above by which fictional data is obtained to train the caption generator 48 with data visualizations of fictional data and feedback based thereon from a human audience. Or some embodiments may train a model to simulate human feedback based on a training set of human feedback and then train the caption generator 48 on feedback from the model configured to simulate a human agent, e.g., with reinforcement learning. In some embodiments, this approach is expected to afford a relatively large amount of feedback by taking a human of the loop.

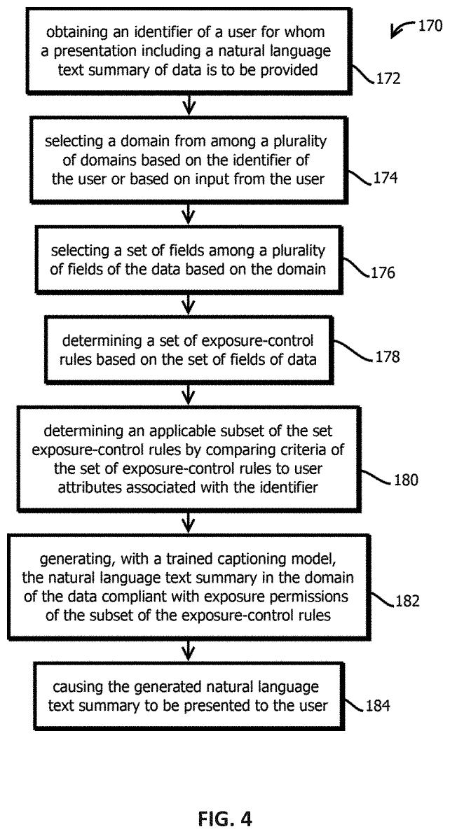

Some embodiments may further include an exposure control module 62 configured to control whether users are afforded access to narrative descriptions or data visualizations based on roles and permissions of users and a domain of the data visualization being summarized or presented, as described in greater detail below with reference to FIG. 4. In some embodiments, exposure control is determined based upon exposure control rules in repository 64, which in some cases may be set by a system administrator or the dashboard designer.

Some embodiments may include an application program interface server 66 by which the narrative generator 12 communicates with the other components via the network 28 in the computing environment 10. The server may also be a nonblocking server configured to route request to the controller 46 and push responses back out onto the network at the instruction of the controller 46.

Some embodiments may further include a text-to-speech module 68 configured to convert natural language text encoded in a text format into audio, for instance, in streaming audio. Some embodiments may also include a speech-to-text module 70 configured to perform the reverse of that transformation, for instance, by receiving audio captured by a microphone of a user computing device and translating that audio into natural language text in a text format suitable for processing as a text query. In some embodiments, the narrative generator 12 is configured to support a chat bot interface by which users may supplied natural language text questions, in some cases responsive to previous natural language text output by the narrative generator 12 either in audio or text format. In some embodiments, the controller 46 is operative to adjust dashboards in an interactive dashboard application responsive to these text inputs or other user inputs and generate updated or new natural language text descriptions descriptive of the update responsive to the query and, in some cases, disambiguate the query based upon a context in a logged history of exchanges in a given chat session, e.g., mapping a pronoun to a preceding noun uttered by the user in the session.

Generating Natural-Language Text Descriptions of Data Visualizations

Data visualization is a powerful means of delivering information to a viewer. It is often said that an image is worth a thousand words. Although we all have experienced a moment of comprehending a picture when we say to ourselves “Now I understand that this visualization means { . . . put short summary statement here . . . }”. That short summary is a text capturing take away points is often much shorter than a thousand words.

The inventors have recognized that it is desirable to capture those words using AI. Some embodiments harvest such words from the intelligence of the dashboard visualization designer and algorithmically generate suggestions of natural language text document describing take away points of the visuals as dashboard is being rendered for a user. Some embodiments afford a system and method for creation of natural language text describing main takeaway points of a visual communication (e.g., a chart, map, diagram, etc.) that an observer would have understand by comprehending the visuals.

The narrative description may be created with a variety of techniques. Dashboards are often designed with a specific use case and set of claims in mind. The visuals created by dashboard designer often provide visual clues that allow user to draw conclusions about the claims in context of the dashboard usage use case. Some embodiments capture events from a design tool of dashboard designer that expose design decisions made the designer.

For example, when dashboard designer places a dial (like than in FIG. 6) expressing current revenue and a notch that identifies target of revenue on the dial, some embodiments capture the event of placing the target on the dial and requests narrative descriptions. Dashboard events that may cause some embodiments to prompt descriptions include the following:
limit or target mark a displayed metric might reach,
comparison of multiple metrics is designed,
Context visual for a metric (like an icon showing degree of achievement of the metric)
Alarm mark is placed
A generalization of metrics (trend, average, max, min, etc.)
Convergence/divergence chart
Retrospective data combined with predictive data to show trend
Color encoding of metric values
Key metrics
Ranking based on summarization of metrics
Claims made with pre-attentive visual features
If metric reaches mark set out as pre-attentive feature, an alarm may be generated in the narrative
Closeness to the mark might also deserves mention
What-if analysis
Evidence for compromise that is made with dashboard.
Advanced narration system might also suggest decision that should be taken
If histogram charts are involved, embodiments might infer a generalization of an underlying distribution, e.g., “looks like Bell curve” or “looks like Power Law curve.”

In some embodiments, narration design is interleaved within dashboard design process. The process may include: 1) Solicitation of text suggestions from dashboard designer; 2) Creating templates and rules for text generation; and 3) Training narrative through repetitive data simulation, narrative generation, and narration feedback.

Solicitation of text suggestions may occur when a dashboard designer defines a visual reorientation of data with a goal to induce viewer of the dashboard to produce an idea of what data indicates (a claim) during design of visuals of dashboard. Some embodiments prompt the user to express a few words about the claim that the designer expects to produce in the mind of the viewer. Embodiments collect notes and append them to an output log so that at the end of the process of visual design there is document with compilation of claims made in the dashboard design.

Creating templates and rules may be achieved by analyzing content of this document to produce a set of rules that contain preconditions evaluated over source data of the dashboard and relationships between data expressed in the dashboard design in the “if” part of the rules and template snippets of narratives in the “then” part of the rules.

Training a resulting narrative-generation model may be performed by repeatedly generating random artificial data set for creating a dashboard and rendering dashboard and narrative text. Some embodiments solicit input from a human trainer. The human trainer may grade the text narrative quality and provides refined text back to the system. Some embodiments collect the refinements and creates updated templates and rules. This process repeats with one or more human trainers in some cases. Some embodiments iterate until quality of generated narrative is satisfactory to the human trainers.

FIG. 2 shows an example of a process 100 that may be implemented by the dashboard application 14 and narrative generator 12 of FIG. 1, but which is not limited to that implementation, which is not to suggest that any other feature herein is limited to the described arrangement. The same is true of the processes described below with reference to FIGS. 3 through 5. In some embodiments, the functionality of the process 100 and the other functionality described herein may be implemented with program code or other instructions stored on a tangible, non-transitory, machine-readable medium, such that when those instructions are executed by one or more processors, the described functionality is effectuated. Notwithstanding use of the singular term “medium,” the medium may be distributed, for instance, with different instructions stored on different computing devices, such that when the different subsets of instruction are executed by different processors the described functionality is effectuated, an arrangement consistent with use of the singular term medium. The described operations in the functionality described herein may be executed in a different order, some operations may be inserted, some operations may be omitted, and various permutations of the operations may be executed serially or concurrently, in some cases in replicated instances of the described modules from FIG. 1, for instance behind a load balancer.

In some embodiments, the process 100 may generate natural language text descriptions of phenomenon appearing in data visualization instances. In some embodiments, the process 100 begins with obtaining a record specifying a data visualization via a dashboard design application, as indicated by block 102. In some embodiments, this record may be specified by a dashboard designer during a design session with the dashboard-design application 30, as described above. Some embodiments may further obtain a set of candidate captions associated with the data visualization, as indicated by block 104. In some embodiments, the candidate captions are the explicit natural language text descriptions supplied by the dashboard designer when designing the data visualization corresponding to the obtained record in step one of two. Or in some cases, the set of candidate captions are implicitly encoded in parameters of a trained natural language text generation model like that described above. Some embodiments further include obtaining criteria designating whether the candidate captions are descriptive of potential instances of the data visualization, as indicated by block 106. Again, in some cases these criteria are criteria of rule supplied by the dashboard designer when designing the data visualization or the criteria may be encoded in the parameters of a trained natural language text generation model like that described above.

Some embodiments may refine the criteria with a pre-release training process described above and subsequent operations. For example, some embodiments may generate fictional data to simulate nonfictional data for which the data visualization is designed to depict, as indicated by block 108. For example, some embodiments may generate fictional data with the techniques described above, for instance, supplying random values for each of the fields depicted in the data visualization or collection of data visualizations in a dashboard, or sampling from a historical log of such data or using a trained machine learning module to simulate such data. Generating may be performed by selecting among extant data or forming new values for each of the fields.

Some embodiments include producing a plurality of simulated instances of the data visualization, as indicated by block 110. In some embodiments, each instance may have a different subset of the generated fictional data, thereby causing the instance to depict a different state of the data visualization. As noted above, the instances of data visualizations need not be displayed on a user interface to constitute an instance of a data visualization, though in some cases, some embodiments may cause them to be depicted.

Some embodiments include determining which of the captions apply to each of the simulated instances of the data visualization based on whether the simulated instances satisfy corresponding criteria among the obtained criteria, as indicated by block 112. Some embodiments may iterate through each of the criteria and determine whether the corresponding caption applies in virtue of the criteria being satisfied. Some embodiments may apply the criteria concurrently, for instance, in processes implemented on a plurality of computing devices, for example, in a MapReduce framework. In some embodiments, each of the data visualization instances may similarly be processed concurrently. In some embodiments, this operation may further include scoring and ranking the captions determined to apply based upon relevant scores, and in some cases, filtering those captions deemed to apply but being of less than a threshold rank, for example selecting a top ranking candidate caption by relevance score or a top two or three applicable captions in such a ranking.

Some embodiments include causing captions determined to be applicable to be presented in visual association with corresponding simulated instances of the data visualization to which the captions apply, as indicated by block 114. In some embodiments, this may include causing the instance of a given data visualization to be presented on a display screen of the user computing device adjacent a caption determined to apply to that instance of the data visualization. In some embodiments, causing the presentation may include sending instructions to another computing device that cause that other computing device to render and display the data visualization and associated caption, for example, sending hypertext markup language instructions, styling instructions, and JavaScript™ instructions, or in some cases, the captions may be determined to apply and may be displayed on the same computing device.

In some embodiments, the captions may be presented in a user interface having user interface inputs, like radio buttons, text fields, sliders, selectable icons, or the like by which a user may provide feedback on various dimensions of the presentation, examples including the various types of feedback described above indicative of whether the displayed caption does in fact apply in the user's view, relevance of the display caption, whether the specificity of the caption is suitable for the user, and the like.

Some embodiments include receiving feedback indicative of whether the presented captions are perceived as descriptive by the user, as indicated by block 116, for example, via these user inputs in the user interface presented in operation 114.

Some embodiments include adjusting the criteria applied in block 112 and obtained in blocks 104 and 106 based on the feedback, as indicated by block 118. In some embodiments, the adjustments may take the form of the adjustments described above with reference to FIG. 1. Some embodiments may store the adjusted criteria in memory, as indicated by block 120, for example in persistent or dynamic memory, like in transient program state.

Some embodiments may determine whether to continue training, as indicated by block 124. Some embodiments may continue training until a stopping condition is detected. Examples of stop conditions include an iteration count exceeding a threshold number of iterations of training, or a determination that aggregate amounts of adjustments between criteria in consecutive iterations is less than a threshold. Upon determining not to stop, embodiments may return to block 112 and determine which captions apply to each of the simulated instances of the data visualizations. Some embodiments may return to block 108 and generate new fictional data to simulate new instances, or some embodiments may recycle the same set of instances of data visualizations or sample from a set of instances of data visualizations, for example randomly. In some embodiments, the instances of data visualizations processed in subsequent iterations may be selected or otherwise generated based upon adjustments to criteria, for example, causing data visualization instances that test the adjusted criteria to be presented.

Alternatively, upon determining that a stopping condition has occurred, embodiments may release the resulting system to production. In some embodiments, this may include obtaining nonfictional data, as indicated by block 126, for example, from the monitored system 16 above or monitored-system data repository 18. In some cases, the nonfictional data is obtained in real time from various sensors of the monitored system, for example within 50 ms, 500 ms, five seconds, or five minutes of generation of the data. Or in some embodiments, the nonfictional data is obtained as part of a batch process by which a dashboard is updated, for example but every minute, every hour, every day, every week, or more or less often.

Some embodiments may receive a request for a dashboard including the data visualization, as indicated by block 128, for example from a user computing device, and some embodiments may generate an instance of the data visualization based on the nonfictional data, as indicated by block 130. In some embodiments, the nonfictional data may be obtained responsive to the request in block 128, or vice versa. In some embodiments, the request may be generated in block 128 responsive to an event in the nonfictional data 126. In some cases, generating the instance of the data visualization based on the nonfictional data may be performed by the above-describe dashboard application 14, such as the dashboard-presentation application 32.

Some embodiments may apply the adjusted criteria to the instance of the data visualization based on the nonfictional data to determine which captions apply, as indicated by block 132. In some cases, this operation may be performed by the above-describe narrative generator 12, and in some cases, this may include determining values that are assigned to variables in a template caption or generating a natural language text caption with a trained natural language text generation model. Some embodiments may apply the adjusted criteria to the instance to determine which captions apply.

Some embodiments may cause captions determined to apply to be logged or to be presented to a user, as indicated by block 134. In some cases, this may include writing the caption to log 20 of FIG. 1 or causing the caption to be presented either in audio or text format on one of the above-described user computing devices 24 or 26. In some cases, this may include sending a push notification or responding to a pull request.

Narration System for Interactive Dashboards

Some embodiments may address some of the above described problems within the context of an interactive dashboard. Some embodiments perform selection-based generation of natural language text narratives. For instance, a user may select a set of values in an interactive dashboard and requests generation of an update-style report in natural language form for selected set of values. Some embodiments perform simulation-based generation of natural language text narratives with the following process. First, the user issues command for generating a narrative of an analytic dashboard for a desired range of analysis settings (default or deliberately selected by users). Second, embodiments start an iterative process of an exhaustive search through possible combination of parameters of the dashboard in the range of user defined values. In some embodiments, the system searches through entire space of values, e.g., by applying techniques implemented by constraint satisfaction solvers. In some embodiments, the system follows a set of pre-defined what-if scenario analysis to reduce the space of search to a-priory defined analysis scenarios. In some embodiments, for a limited set of metrics, the system produces projections for future values of time using on trained predictive models of data underlying dashboard using gradations of time presented in the charts, e.g., if charts present time in quarter increments, than prediction should be made for next quarter. Third, for each configuration, some embodiments simulates a virtual dashboard combination of parameters, and the system performs the actions described above and adds generated narrative to an output log. Fourth, some embodiments use text summarization AI system to generate a relatively concise summary of entire log of the dashboard analysis. Fifth, some embodiments separate text into narrative, alerts, and warning sections. Sixth, some embodiments render output of step 4 in a human readable format and return text as the response to the user requesting it in the first step. In some embodiments, these techniques are implemented to provide a guided exploration of interactive dashboards. For instance, in the fourth step, where along, or instead of, generating a concise summary, some embodiments guide the user through interesting combinations of values in visual way and provide a “guided walkthrough” for the interactive dashboard for the combination of values that generated alarms or suggestions. For instance, some embodiments may determine a sequence of data visualization instances that are likely to be relevant for the user based on natural language text descriptions thereof and present the text, the data visualization instances, or both in that sequence.

FIG. 3 is a flowchart showing another example of a process 150 by which the above-describe natural language text captions may be presented in the context of an interactive dashboard application. Interactive dashboard applications include inputs in the instances of dashboard by which users may mutate the presentation of information. Examples include inputs by which users may adjust ranges of axes, adjust which fields are depicted, adjust mappings of fields to visual attributes of data visualizations, change the types of charts shown, input queries to specify which data is depicted, and the like.

In some embodiments, the process 150 includes causing an instance of an interactive dashboard from an interactive dashboard application to be presented to a user, as indicated by block 152. In some embodiments, this may include receiving a request for an interactive dashboard instance from a remote user computing device or from a user computing device executing the process 150. Causing the interactive dashboard to be presented may include sending instructions that when executed in a web browser cause the interactive dashboard application to be presented in a web browser interface, or instructions may be sent to a native application or may be sent to an API of a windowing system of a host computing device.

In some embodiments, the process 150 includes receiving a command corresponding to user input to the interactive dashboard application from the user, as indicated by block 154. In some cases, the command may be an event in a user interface indicative of a user selection of a user interface input element, like clicking a button, selecting a radio button, submitting text, submitting audio, inputting a gesture on a touchscreen, or the like. In some cases, the command may be a request to interact with the interactive dashboard in one or more of the above-described manners. Or in some cases, the command corresponding to user input may be a simulated user implementing the above techniques to explore the data, e.g., in a guided walk-through are applying techniques like those used in constraint solvers.

Some embodiments may include producing, in response to the command, instances of data visualizations depicting data is to be visualized, as indicated by block 156. In some cases, this may include adjusting which type of data visualizations presented, adjusting mappings of fields to axes or other visual attributes of data visualizations, adjusting which data is depicted, or the like, as specified in the received command.

Some embodiments include generating, with a trained captioning model, narrative captions determined to be descriptive of the produced instances of data visualizations, as indicated by block 158. In some embodiments, this operation may be performed by the above-describe narrative generator 12, for example by applying criteria indicative of which text descriptions apply to the produced instances of data visualizations from block 156. In some embodiments, the generation of narrative captions may be based on context from a session in which multiple interactions are received with the interactive dashboard. For example, a sequence of interactions may indicate that a user is exploring a particular domain, as described below, correlation, or field or phenomenon, and some embodiments may adjust relevance scores of captions determined to be applicable based on that context, for example up weighting captions associated with such items. As noted, narrative captions may be grouped and presented under various headings, like narrative, alerts, and warning sections. In some cases, the designer may apply this classification to the text descriptions, or embodiments may infer these classifications based on semantic similarity to other labeled bodies of text in a training corpus.

Some embodiments include causing the one or more narrative captions from block 158 to be presented to the user, as indicated by block 160. In some embodiments, presentation may include presenting both the produced instances from block 156 and the narrative captions, or in some cases, the narrative captions may be presented to the user without providing the instances of data visualizations from block 156. In some embodiments, the command and the response from block 160 may be in natural language text, for example, presented in the context of a chat bot by which a user may explore data set conversationally. An example use case might include requesting a summary of a dashboard for the sales activity in the eastern half of the United States and then requesting a listing of the lowest performing sales people in “that region” based on the summary. In some cases, the subsequent request may be disambiguate “that region” based on the context, for example a user may request the “bottom three sales people in the region,” and the process 150 may disambiguate “the region” to mean the region corresponding to the eastern half of the United States as specified in an earlier interaction in the session.

Content Exposure and Styling Control for Visualization Rendering and Narration Using Data Domain Rules

In some cases, data presented through visualization might contain information that is deemed to be sensitive and undesirable for exposure. Computer resource security often restricts access to entire data source using access control mechanisms that are too coarse for parts of the content protected by it. For example, a physician may have access to a medical record of patient according to access control rules, but when physician generates a charts or reports of medical record meant for consumption by a third party, the access control rules may not stop the physician from revealing private patient data.

To mitigate these issues, some embodiments obtain the identity of the user requesting a visualization or other report and, then, apply exposure rules control rule that directs the narrative generator to render sentences of the story according to pre-defined (or dynamically defined) exposure rules for the content of generated text based on the requesting user for given domain of data narrative.

In some embodiments, visualizations or text are generated according to rules defined for a category of authorization of the reader (or style) data for each domain and subdomain of the story. Some embodiments obtain assertions associated with the requesting user and data domains of the visualization. Some embodiments produce output (e.g., graphical or textual) based on rules for assertions about a user and data domain of the visualization. This process may implement styling for data domains like those listed below. Some embodiments apply such styling at the time of generating visual representations. In some embodiment, the technique can be used for rendering role-based content. In some embodiments, custom text is generated during rendering of the output text. In some embodiments, text rendering (or other forms of generation) produces narrative based on assertions about the requested user, but in post processing, data is filtered out according to content-exposure rules.

For example, if the person requesting a report is permitted to view personal data of a user, some embodiments, in response, generate text or graphics that reveals data in the Persona: Identity domain (see below) in the generated representations. In another example, if the person requesting information is in another time zone than the time zone where data was originally collected, then time zone and calendar in the description of the story or generated visuals may be transposed for the location of the requesting user.

FIG. 4 shows an embodiment of a process 170 by which domain and user-specific styling may be applied to data visualizations in dashboards and by which exposure to information in those instances of data visualizations that result may be controlled. In some cases, it may be desirable to control which users receive which narrative text descriptions for a given data visualization to maintain access controls within an organization for certain types of information. For example, a dashboard relating to salary expenditures may be summarized for one user as indicating that salaries across the whole company are up 10% while another user may receive a narrative summary indicating that salaries for three specific employees identified by name are up 40%, depending upon whether the corresponding users are permitted to access the underlying information.

In some embodiments, the process 170 includes obtaining an identifier of a user for whom a presentation including a natural language text summary of data is to be provided, as indicated by block 172. In some embodiments, this identifier may be supplied by a user when logging into an application by which the narrative text summaries are accessed, for instance, on the user's computing device. In some embodiments, the identifier may be provided in association with an access credential, like a password or cryptographic hash thereof, by which the user's identity may be authenticated and authorization to access various types of information may be determined.

Some embodiments include selecting a domain from among a plurality of domains based on the identifier of the user or based on input from the user, as indicated by block 154. For example, a user identifier may be associated with the user profile including a job title or other indication of a role within a company, and that role may be mapped to a particular domain that is selected in block 174, or a user may expressly request a particular domain of data visualizations via user input to an interactive dashboard application. In some embodiments, the information presented from interactive and other dashboard applications may be embedded in some other application, like a webpage or other document containing information from other sources.

The domains may be any of a variety of different domains by which information may be presented, examples including the following. Generally, the domain is a category describing context in which plot of the visualized story develops. User may have certain familiarity with domain of the story. If user is not familiar with the domain, the user may not be able to relate to the story.

| Time | story develops in time |
|---|---|
| a. Anticipatory domain | story develops in the future |
| i. from now on | |
| b. Retrospective domain | story developed in the past |
| i. up-to-now | |
| c. This moment | story is happening this exact moment |
| Divisions of time domain | |
| d. Calendar | |
| e. Units of time | |
| Space | story develops in space |
| a. Geography | divisions of map |
| i. Political | |
| ii. Topological | |
| b. Schematic | divisions of a plan or blueprint |
| Actor domain | |
| a. Identity | personal data of an individual |
| b. Demographic | generalized population data |
| c. Organization | data about a company |
| d. Political | data about a politically-economic entity |
| Metric domain | |
| a. Numeric | domain of metrics expressed as infinite numeric |
| | values |
| b. Categorical | domain of metric as a finite set of labels or |
| | numbers |
| Frequency Domain | domain of repeated occurrences of phenomena |
| Composition Domain | domain of parts composing whole |
| Tangible Value Domain | domain of tangibles (money, property, etc.) |
| Intangible Value Domain | domain of intangibles (safety, privacy, etc.) |
| Abstraction Domain | domain of abstract ideas that can be applied |
| | broadly |
| a. Generalization | |
| b. Categorization | |
| c. Conceptualization | |
| Boundary domain | |
| a. Internal | data is about phenomena inside of a system, |
| | company, country, |
| b. External | same, above, but about phenomena outside |
| Action domain | domain of animate actors or groups (person, |
| | state, etc.) |
| a. Private | private action is not visible outside actors of the |
| b. Public | |
| c. Decision | |
| d. Responsibility | |
| e. Propose | |
| f. Interest | |
| g. Reversible | action that cannot be undone |
| h. Irreversible | action that can be undone |
| Trust/validity domain | |
| a. Witness | authority and authenticity comes from a |
| | person |
| b. Evidence | authority and authenticity comes from data |
| Origin Domain | |
| a. Observation | |
| b. Simulation | |
| c. Speculation | |
| d. Prediction | |

In some embodiments, each of those domains may correspond to a particular dashboard design specification record like those described above or a particular configuration of such a record.

In some embodiments the process 170 may include selecting a set of fields among a plurality of fields of the data of the system being monitored based on the domain, as indicated by block 176. In some cases, the fields are extant fields within the data emitted by the system being monitored, or in some cases the fields are based on transformations of the data, like a moving average.

Some embodiments may determine a set of exposure-control rules based on the set of fields of data, as indicated by block 178. In some embodiments, these operations may be performed by the above-described exposure control module 62 of FIG. 1 by operation based on exposure-control rules in repository 64. In some embodiments, exposure control rules may be specified for each job title or other indicator of role within an organization as mapped to the user via the user's profile associated with the user identifier obtained a block 172, or some embodiments may explicitly directly map exposure-control rules to the user identifier in memory. In some embodiments, the exposure-control rules may indicate fields of data the user is permitted to access, the user is prohibited from access, or conditions under which the user is permitted or prohibited to access. In some embodiments, the exposure-control rules may be indexed to the user or to the fields of data. For example, some exposure-control rules may instead be mapped to a given field of data and indicate criteria by which users are determined to be permitted to or prohibited from accessing the field.

Some embodiments include determining an applicable subset of the exposure-control rules by comparing criteria of the set of exposure control rules to user attributes associated with the identifier, as indicated by block 180. In some embodiments, this may include determining whether the user is on a prohibited list or permitted list or the user's job title or other indicator of role in organization is on a permitted or prohibited list. In some embodiments, this operation may be performed by determining whether the fields corresponding to the exposure-control rules are on a permitted or prohibited list for the user associated with the identifier or other indicator of role in organization.

Some embodiments include generating, with the trained captioning model, like those described above, the natural language text summary in the domain of the data compliant with exposure permissions of the subset of exposure-control rules, as indicated by block 182. In some embodiments, this operation may include determining whether each of a plurality of candidate natural language text descriptions are permissible to be exposed to the user associated with the identifier. Some embodiments may iterate downward through a ranking of exposure-control rules by relevance until an exposure-control rule or threshold number of exposure-control-rules compliant natural language text descriptions are selected.

Or some embodiments may manage exposure control via the criteria of the candidate natural language text descriptions. Some embodiments include in the criteria associated with natural language text descriptions values that are compared to criteria of the exposure-control rules in the subset, for example scores from 0 to 5 indicating a level of security clearance or privileged access in a corresponding natural language text description. Some embodiments may express the same concepts with different levels of generality or specificity with different values indicating different levels of access required for that natural language text description during the design phase. In some embodiments, the exposure control rules may be mapped to the identifier to generate a set of features that are input to a natural language text generation model like that described above, and the natural-language text generation model may generate a natural language text description compliant with the exposure control rules. For example, the mapping may produce a score like that described above from 0 to 5 indicating a level of privileged access that is input as a feature to the natural-language text generation model.

Some embodiments may cause the generated natural language text summary to be presented to the user, as indicated by block 24, for example in any of the manner described above.

Visualization-Dashboard Narration Using Text Summarization

Visualization is a powerful mechanism for data analysis, but the relevance on the sense of sight and limitation of resolution, size or color gamut of visualization equipment often limits usefulness of visualization. Further, often the power of visualization is lost on visually impaired individuals, and many users are further impaired by the capabilities of the a display, like resolution, size and gamut, latency, jitter, pace of change of data etc.

Some embodiments afford a mechanism for rendering of visualization through developing a textual narrative describing visualized data in a cohesive document capturing a story that is intended to be told by the data with further transformation to verbal and aural means of communicating the visualizations. Some embodiments apply methods of text summarization for detecting semantics of charts presented in the dashboards with further alarm generation in case text summarization of the presented data changes to reflect alert-worthy summarization.

Some embodiments can be conceptualized as implementing a dashboard visualization system “rendered” (e.g., purely in memory) on a virtual screen of a size appropriate for rendering multiple charts of data representations at the same time. The virtual screen can be a two-dimensional (three-dimensional for 3D visualizations) memory space on which the charts are rendered by the rendering component. In some embodiments, the virtual screen represents an artificial screen that is as larger as the most detailed visualization capturing all data pertinent to analysis to be visualized. A narrative generation component, like that described above, may be an artificial intelligence component that is trained to produce a textual narrative about the charts drawn on the virtual screen. In some embodiments, the textual narrative mimics a thought process of a human expert analyzing the visualized data.

An example of a resulting narration text might include the following: A scatter plot with time along horizontal axis and value of average observed summer temperatures over along vertical axis. The plot captures 12345 data points starting from year 2000 with a resolution. The system attempted linear regression over the plotted data. The regression model shows trend to annual grown in overage temperature. The regression model also shows increased randomness in temperature reading over time.

In some embodiments, the textual narrative may be created for every one of the charts projected on the virtual screen in such a way that a visualization description text file is produced. In some embodiments, the visualization description file can be summarized and narrated to a user as if user was using a screen reading system, like those used by the visually impaired. The visualization description can be read out as it is, or in a form of a summary that captures meaning of the visualization concisely. In some embodiments, the resulting summarization can also be evaluated from the point of view of certain alarming conditions. If summarization develops a summary that captures presence of the alarming condition, an alert may be produced.

In some embodiments a user can interact with the system using verbal commands. The verbal commands direct data analysis that may be reflected in data narration. The screen reading system may create a control loop for text generation allowing a user to have a conversation with the data analysis system.

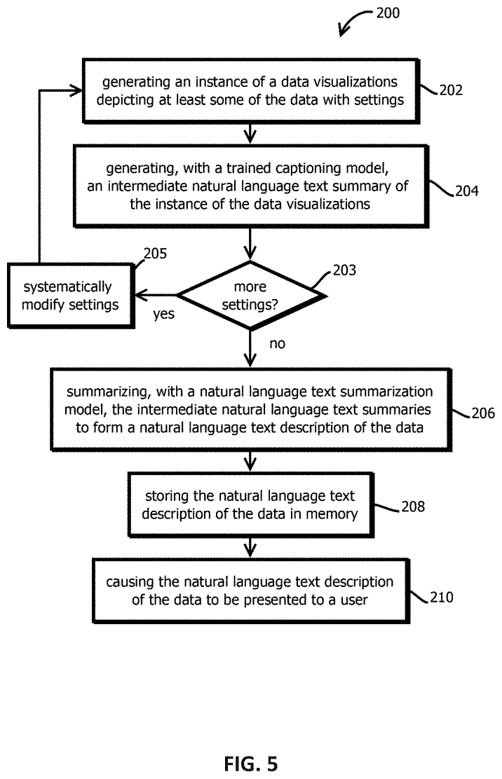

FIG. 5 is a flowchart showing an example of a process 200 by which collections of natural language text summaries of data visualizations may be summarized with a natural language text summarization model for presentation to users. In some embodiments, the process includes generating an instance of a data visualization depicting at least some of the data to be visualized, as indicated by block 202. In some embodiments, this operation may be performed by the above-described dashboard-presentation application 32 of FIG. 1. In some cases, the instance of the data visualization may be generated responsive to user input specifying a particular data visualization or in one of the above-described domains of FIG. 4. In some cases, the data visualization may have a plurality of settings, examples including those visual attributes and types of data visualizations described above, along with ranges of data and mappings of fields to visual attributes. In some embodiments, an initial set of settings may be selected, for example, based on specification of the data visualization or dashboard.

Some embodiments include generating, with the trained captioning model, intermediate natural language text summaries of the instances of data visualizations, as indicated by block 204. In some cases, generating may be performed by the above-described narrative generator 12 in accordance with the techniques described above. In some cases, the intermediate natural language text summaries are not presented to users and are, instead, used as a precursor to summarization operations described below.

Some embodiments may determine whether to adjust the settings of the data visualization, as indicated by blocks 203 and 205. Some embodiments may systematically vary the settings through a configuration space, for example, adjusting each permutation of each setting along a range in a configuration space. Examples including varying the type, field mappings, visual attributes, and the like along each of a plurality of values along each of a plurality of dimensions for each of the settings. Some embodiments may vary the settings in a matrix, for instance, in which columns correspond to individual settings and rows corresponding to values of those individual settings having different values. Some embodiments may return to block 202 with the settings modified by one increment.

Upon determining to continue adjusting setting, some embodiments may adjust the settings, for example, by systematically incrementing the settings to a subsequent permutation in the configuration space, for example, as specified by a sampling regimen specified by a dashboard designer. In some embodiments, the sampling regimen may be specified in the dashboard design record, for example specifying a set of dashboards within the configuration space with the settings and ranges thereof. Some embodiments may then return to block 202 to continue generating instances of data visualizations and intermediate natural language text summaries in block 204.

Alternatively, upon determining that the systematic variation of settings is complete and the configuration space of dashboards specified in the sampling regimen has been fully explored, some embodiments may proceed to block 206 and summarize, with a natural language text summarization model, the intermediate natural language text summaries to form a natural language text description of the data. In some embodiments, this operation station may be performed by the natural language text narrative synthesizer 54 of FIG. 1. In some embodiments, the summarization may be an abstractive summarization formed with an abstractive natural language text summarization model like those described above, or in some embodiments, the summarization may be in extractive summarization, for example, extracting those natural language text summaries among the intermediate natural language text summaries that are determined to be most relevant or most descriptive of the body of intermediate natural language text summaries produced in block 204 for the various instances with the various settings.

In some embodiments, the result may be a natural language text description of a data set that is descriptive of the most relevant phenomenon appearing in the data set that are discovered by exploring a relatively large number of different views of the data. In some embodiments, intermediate natural language text summaries may be generated for more instances of data visualizations than a human could reasonably cognitively process, for example, more than 100, more than 1000, or more than 10,000, for example within one minute or 10 minutes, and some cases within less than one second of initiating the process 200.

Some embodiments may store the natural language text description of the data in memory, as indicated by block 208, and because the natural language text description of the data to be presented to a user, as indicated by block 210. In some cases, presentation may take the form of any of the various forms of presentation described above.

Intermediate natural language text summaries may be of the form described above by which phenomenon depicted in instances of data visualizations are described with natural language text captions. In some cases, some of these captions may be more relevant than others and some of the captions may relate to the same phenomenon presented in different facets. In some embodiments, the summarization may consolidate or otherwise compress those different descriptions of the same phenomenon in the summary. Some embodiments may consolidate or otherwise cluster the intermediate natural language text descriptions, for example, by clustering within a feature space specified with Latent Semantic Analysis or clustering by topic according to latent Dirichlet allocation. Some embodiments may summarize each resulting cluster, for instance, by providing a natural language text summary of each topic or each cluster. Some embodiments may group the intermediate natural language text descriptions by their cluster and then input the different groups into a natural language text summarization model to produce the summaries of each of the groups. In some embodiments, the summaries may be presented with user inputs, like links, by which a user may navigate through to an underlying set of data, for example, by which a user may select a summary to view the intermediate natural language text summaries upon which that summary is based or the instances of data visualizations upon which those intermediate natural language text summaries are based. Thus, users may explore a data set through relatively concise explanations of what is happening in that data set with a relatively low cognitive load, in some cases extracting insights from more instances of data visualizations than a user can humanly process cognitively.

FIG. 6 shows one example of an instance of a data visualization that illustrates some of the concepts described above. It should be emphasized that this is only an example and embodiments are consistent with, an expected to include, substantially more variety in the types of data visualizations, examples of which are described above, none of which is to suggest that any other description is limiting. In the illustrated example of a data visualization instance 250, the instance includes a gauge chart indicating progress towards a threshold goal 252. The progress is indicated by a bar 254, the angular position of which in the chart indicates progress towards the target 252. The visual indicator 254 moves between a minimum depicted range 256 and a maximum depicted range to 568, the span of which specifies an extent in that particular field of the data visualization instance 250. In some use cases, a designer may, for example, when designing this data visualization upon which instance 250 is based, specify a natural language text description indicating that the goal has not been met and associating that text with a rule that specifies bar 254 must be less than the target 252. Another natural language text description that may be associated with the data visualization during the design phase may indicate that the goal has been exceeded and that text may be associated with a rule having criteria specifying that the bar 254 is to the right of the target 252 or the underlying field has a value greater than that corresponding to the target 252.

The present patent filing is one of a set of four filed on the same day by the same applicant and sharing the same disclosure, members of the set having the following titles: GENERATING NATURAL-LANGUAGE TEXT DESCRIPTIONS OF DATA VISUALIZATIONS; NARRATION SYSTEM FOR INTERACTIVE DASHBOARDS; CONTENT EXPOSURE AND STYLING CONTROL FOR VISUALIZATION RENDERING AND NARRATION USING DATA DOMAIN RULES; VISUALIZATION-DASHBOARD NARRATION USING TEXT SUMMARIZATION. The entire content of each of the patent filings other than this one is hereby incorporated by reference.

FIG. 7 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpindicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:

1. A method, comprising: receiving, with one or more processors, a command corresponding to user input to an interactive dashboard application from a user, wherein: the interactive dashboard application is configured to present a plurality of instances of data visualizations in a dashboard user interface, the dashboard user interface comprises user-interface input elements, and the interactive dashboard application is configured to adjust, responsive to the input elements, which data visualizations are shown, attributes of the data visualizations, or which data is depicted in the interactive dashboard application; producing, with one or more processors, in response to the command, instances of data visualizations depicting data to be visualized; generating, with one or more processors, with a trained captioning model, one or more narrative captions determined to be descriptive of the produced instances of data visualizations, wherein the one or more narrative captions include a natural language description of a phenomenon exhibited, at least in part, by the data to be visualized and visually depicted in at least one of the produced instances of data visualizations; and causing, with one or more processors, the one or more narrative captions to be presented to the user.
2. The method of embodiment 1, wherein: the command is input via one or more of the user-interface input elements; causing the one or more narrative captions to be presented to the user comprises causing a plurality of narrative captions to be presented to the user on a user computing device via a web browser executing on the user computing device; the produced instances of data visualizations include graphs that depict at least some of the data to be visualized; the one or more narrative captions include at least two of the following: an indication that a limit or target mark is predicted to be attained by a displayed metric within a threshold duration of time; an indication that a comparison of multiple metrics indicates a designated amount of difference or correlation between the multiple metrics; a description of a comparisons between multiple values of a single displayed metric; a description of convergence or divergence of two displayed metrics; a description of change in displayed metrics over time; a ranking of multiple displayed metrics or of a single displayed metric over time; a result of a comparison between a displayed metric and a visually depicted threshold of a data visualization; a result of a what-if analysis of displayed metrics; a suggested responsive action to adjust a system characterized by a displayed metric; or an indication of correspondence to a statistical distribution.
3. The method of any one of embodiments 1-2, wherein: at least some of the one or more narrative captions are input and associated with corresponding data visualizations during design of the corresponding data visualizations via a dashboard design application that is the same application or a different application from the interactive dashboard application.
4. The method of any one of embodiments 1-3, wherein: the command selects a subset of data from a data source supplying the data to be visualized and requests an update to an existing dashboard user interface to depict the selected subset of data.
5. The method of embodiment 4, wherein: at least some of the one or more narrative captions describes a change in a depicted metric resulting from the requested update.
6. The method of embodiment 5, wherein generating the one or more narrative captions comprises: comparing values of, or visual attributes of a depiction of, the depicted metric before the update to values of, or visual attributes of the depiction of, the depicted metric after the update.
7. The method of embodiment 4, wherein generating one or more narrative captions comprises: selecting the one or more narrative captions from among a plurality of narrative captions determined to apply to at least some of the produced instances of data visualizations, wherein the selection is based on: a determination that the one or more narrative captions are caused to apply to at least some of the produced instances by the command, and a determination that unselected narrative captions are not caused to apply to at least some of the produced instances by the command.
8. The method of embodiment 1, wherein: the command specifies an envelope in a space of potential instances of data visualizations; and generating the one or more narrative captions comprises: simulating a plurality of the potential instances of data visualizations in the space; determining candidate narrative captions corresponding to each of the potential instances of data visualizations; and determining the one or more narrative captions based on at least some of the candidate narrative captions.
9. The method of embodiment 8, wherein: simulating a plurality of the potential instances of data visualizations in the space comprises a brute-force search of every permutation of values of dimensions of at least part of the space specified by a sampling regime.
10. The method of embodiment 8, wherein: simulating a plurality of the potential instances of data visualizations in the space comprises stochastically sampling the space.
11. The method of embodiment 8, wherein: simulating a plurality of the potential instances of data visualizations in the space comprises traversing a plurality of paths through a decision tree having leaf nodes specifying points in the space and non-leaf nodes corresponding to responsive actions taken based on predicted values of displayed metrics.
12. The method of embodiment 8, simulating a plurality of the potential instances of data visualizations in the space comprises sampling the space based on probability distributions of values of at least some dimensions of the space.
13. The method of embodiment 8, wherein simulating a plurality of the potential instances of data visualizations in the space comprises: inputting a current or projected set of metrics among the data to be visualized into a predictive model configured to output predicted values of at least some of the data to visualized; and configuring the potential instances of data visualizations based on predicted values output by the predictive model.
14. The method of any one of embodiments 1-13, wherein generating one or more narrative captions comprises: inputting a plurality of intermediate narrative captions determined to be descriptive of produced instances of the data visualizations into a natural-language-processing text-summarization model that generates text of the one or more narrative captions.
15. The method of embodiment 14, wherein the text summarization model is an abstractive-text-summarization recurrent neural network configured to generate phrases absent from the intermediate narrative captions.
16. The method of embodiment 14, wherein: generating one or more narrative captions comprises classifying the intermediate narrative captions according to an ontology of narrative captions; and causing the one or more narrative captions to be presented comprises causing the intermediate narrative captions to be presented in visual association with an indication of results of the classifying.
17. The method of embodiment 8, comprising: selecting a subset of the plurality of the potential instances of data visualizations based on entropy of corresponding candidate narrative captions; and causing candidate narrative captions of the selected subset to be presented to the user in a guided tour of potential scenarios of a system characterized by the data to be visualized.
18. A tangible, non-transitory, machine-readable medium storing instructions that when executed by a data processing apparatus cause the data processing apparatus to perform operations comprising: the operations of any one of embodiments 1-17.
19. A system, comprising: one or more processors; and memory storing instructions that when executed by the processors cause the processors to effectuate operations comprising: the operations of any one of embodiments 1-17.

What is claimed is:

1. A method, comprising:
receiving, with one or more processors, a command corresponding to user input to an interactive dashboard application from a user, wherein:
the interactive dashboard application is configured to present a plurality of instances of data visualizations in a dashboard user interface,
the dashboard user interface comprises user-interface input elements, and
the interactive dashboard application is configured to adjust, responsive to the input elements, which data visualizations are shown, attributes of the data visualizations, or which data is depicted in the interactive dashboard application;
producing, with one or more processors, in response to the command, instances of data visualizations depicting data to be visualized;
generating, with one or more processors, with a trained captioning model, one or more narrative captions determined to be descriptive of the produced instances of data visualizations, wherein the one or more narrative captions include a natural language description of a phenomenon exhibited, at least in part, by the data to be visualized and visually depicted in at least one of the produced instances of data visualizations; and
causing, with one or more processors, the one or more narrative captions to be presented to the user.

2. The method of claim 1, wherein:
the command is input via one or more of the user-interface input elements;
causing the one or more narrative captions to be presented to the user comprises causing a plurality of narrative captions to be presented to the user on a user computing device via a web browser executing on the user computing device;
the produced instances of data visualizations include graphs that depict at least some of the data to be visualized;
the one or more narrative captions include at least two of the following:
an indication that a limit or target mark is predicted to be attained by a displayed metric within a threshold duration of time;
an indication that a comparison of multiple metrics indicates a designated amount of difference or correlation between the multiple metrics;
a description of a comparisons between multiple values of a single displayed metric;
a description of convergence or divergence of two displayed metrics;
a description of change in displayed metrics over time;
a ranking of multiple displayed metrics or of a single displayed metric over time;
a result of a comparison between a displayed metric and a visually depicted threshold of a data visualization;
a result of a what-if analysis of displayed metrics;
a suggested responsive action to adjust a system characterized by a displayed metric; or
an indication of correspondence to a statistical distribution.

3. The method of claim 1, wherein:
at least some of the one or more narrative captions are input and associated with corresponding data visualizations during design of the corresponding data visualizations via a dashboard design application that is the same application or a different application from the interactive dashboard application.

4. The method of claim 1, wherein:
the command selects a subset of data from a data source supplying the data to be visualized and requests an update to an existing dashboard user interface to depict the selected subset of data.

5. The method of claim 4, wherein:
at least some of the one or more narrative captions describes a change in a depicted metric resulting from the requested update.

6. The method of claim 5, wherein generating the one or more narrative captions comprises:
comparing values of, or visual attributes of a depiction of, the depicted metric before the update to values of, or visual attributes of the depiction of, the depicted metric after the update.

7. The method of claim 4, wherein generating one or more narrative captions comprises:
selecting the one or more narrative captions from among a plurality of narrative captions determined to apply to at least some of the produced instances of data visualizations, wherein the selection is based on:
a determination that the one or more narrative captions are caused to apply to at least some of the produced instances by the command, and
a determination that unselected narrative captions are not caused to apply to at least some of the produced instances by the command.

8. The method of claim 1, wherein:
the command specifies an envelope in a space of potential instances of data visualizations; and
generating the one or more narrative captions comprises:
simulating a plurality of the potential instances of data visualizations in the space;
determining candidate narrative captions corresponding to each of the potential instances of data visualizations; and
determining the one or more narrative captions based on at least some of the candidate narrative captions.

9. The method of claim 8, wherein:
simulating a plurality of the potential instances of data visualizations in the space comprises a brute-force search of every permutation of values of dimensions of at least part of the space specified by a sampling regime.

10. The method of claim 8, wherein:
simulating a plurality of the potential instances of data visualizations in the space comprises stochastically sampling the space.

11. The method of claim 8, wherein:
simulating a plurality of the potential instances of data visualizations in the space comprises traversing a plurality of paths through a decision tree having leaf nodes specifying points in the space and non-leaf nodes corresponding to responsive actions taken based on predicted values of displayed metrics.

12. The method of claim 8, wherein:
simulating a plurality of the potential instances of data visualizations in the space comprises sampling the space based on probability distributions of values of at least some dimensions of the space.

13. The method of claim 8, wherein simulating a plurality of the potential instances of data visualizations in the space comprises:
inputting a current or projected set of metrics among the data to be visualized into a predictive model configured to output predicted values of at least some of the data to visualized; and
configuring the potential instances of data visualizations based on predicted values output by the predictive model.

14. The method of claim 1, wherein generating one or more narrative captions comprises:
inputting a plurality of intermediate narrative captions determined to be descriptive of produced instances of the data visualizations into a natural-language-processing text-summarization model that generates text of the one or more narrative captions.

15. The method of claim 14, wherein the text summarization model is an abstractive-text-summarization recurrent neural network configured to generate phrases absent from the intermediate narrative captions.

16. The method of claim 14, wherein:
generating one or more narrative captions comprises classifying the intermediate narrative captions according to an ontology of narrative captions; and
causing the one or more narrative captions to be presented comprises causing the intermediate narrative captions to be presented in visual association with an indication of results of the classifying.

17. The method of claim 8, comprising:
selecting a subset of the plurality of the potential instances of data visualizations based on entropy of corresponding candidate narrative captions; and
causing candidate narrative captions of the selected subset to be presented to the user in a guided tour of potential scenarios of a system characterized by the data to be visualized.

18. A tangible, non-transitory, machine-readable medium storing instructions that when executed by one or more processors effectuate operations comprising:
receiving, with one or more processors, a command corresponding to user input to an interactive dashboard application from a user, wherein:
the interactive dashboard application is configures to present a plurality of instances of data visualizations in a dashboard user interface,
the dashboard user interface comprises user-interface input elements, and
the interactive dashboard application is configured to adjust, responsive to the input elements, which data visualizations are shown, attributes of the data visualizations, or which data is depicted in the interactive dashboard application;
producing, with one or more processors, in response to the command, instances of data visualizations depicting data to be visualized;
generating, with one or more processors, with a trained captioning model, one or more narrative captions determined to be descriptive of the produced instances of data visualizations, wherein the one or more narrative captions include a natural language description of a phenomenon exhibited, at least in part, by the data to be visualized and visually depicted in at least one of the produced instances of data visualizations; and
causing, with one or more processors, the one or more narrative captions to be presented to the user.

19. The medium of claim 18, wherein:
the command selects a subset of data from a data source supplying the data to be visualized and requests an update to an existing dashboard user interface to depict the selected subset of data.

20. The medium of claim 18, wherein:
the command specifies an envelope in a space of potential instances of data visualizations; and
generating the one or more narrative captions comprises:
simulating a plurality of the potential instances of data visualizations in the space;
determining candidate narrative captions corresponding to each of the potential instances of data visualizations; and
determining the one or more narrative captions based on at least some of the candidate narrative captions.
